(19) United States
(12) Patent Application Publication
(10) Pub. No.: US 2004/0010553 A1
(43) Pub. Date: Jan. 15, 2004

(54) Peer to peer location based services

(75) Inventors: Neil Katz, Parkland, FL (US); Victor S. Moore, Boynton Beach, FL (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY

(21) Appl. No.: 10/195,294

(22) Filed: Jul. 15, 2002

(51) Int. Cl. G06F 15/16

(52) U.S. Cl. 709/206; 709/238

(57) ABSTRACT

A method and machine readable storage for specifying a query and determining the geographic location of a communication device. The query and geographic location are incorporated into a message digest, which can be a hash. At least one network node, which can be an additional communication device, is determined and the message digest is sent to the network node using a peer to peer protocol. Geographic locations of the communication device and/or the network node can be determined by a positioning system, such as a mobile positioning center and/or a global positioning satellite. The network node can compare the geographic location of the communication device to a geographic location of the network node and generate a location comparison. The network node then can perform at least one processing step responsive to the query and the location comparison. For example, the network node can forward the message digest to at least one additional network node.

### BACKGROUND OF THE INVENTION

1. Technical Field

This invention relates to the field of network communications, and more particularly, to peer to peer network solutions.

2. Description of the Related Art

Peer to peer networking protocols, such as Gnutella, FreeNet, BEEP, MIME, SOAP and TCP, provide unique file sharing capabilities among Internet users and facilitate the implementation of distributed computing. Accordingly, peer to peer networking protocols have become quite pervasive in recent years. Moreover, the use of peer to peer networks is likely to expand as the technology continues to evolve. For example, new technologies based on peer to peer networking are embodied in the recently announced Grid Computing initiative sponsored by IBM and the Web services initiatives sponsored by the Web Services Interoperability Organization.

Essentially, peer to peer communications leverages Internet technology to allow devices in a network to operate as both clients and servers where the functionality and capability of each device is not limited by its place in a network hierarchy. In general, peer to peer implies that there is no central server used for routing, locating, and transporting messages or traffic, although this is not necessarily always the case. For example, some protocols rely upon a central directory structure for queries by computers looking for specific content. Once the requested content is located in the directory, however, the source of the content and the requester of the content operate as peers such that content can be shared among the peer to peer nodes without interaction with a central server.

On the other hand, other protocols implement true peer to peer solutions without the need for a central directory structure. In one solution, for example, a request to find content is sent to a first identified network node using one of many techniques known in the art, such as storing in each client a set of start nodes accessible by clients. The content request can specify search parameters or a query. A client can cycle through the set of start nodes and sequentially ping each start node until a response is received, at which time the client can forward the content request to the responding start node. If the responding start node is not able to satisfy the request, the responding start node can send the content request out to other nodes in the responding node's directory. These remote nodes then search to determine if the requested content is contained in local directories associated with the remote nodes. If not, the remote nodes can forward the request on to a next set of nodes.

Peer to peer protocols commonly include time to live (TTL) parameters in content requests where each node decrements a TTL counter by 1 each time a content request is forwarded to new nodes. This process continues until the TTL counter becomes equal to zero, a point at which the content request is no longer propagated. Thus, the TTL parameter prevents an endless search for content that might not be available in the search path.

Each request for content typically has a unique message digest, which can be a 15 hash derived from the content request and the originator's identification. A hash is short fixed-length value or key generated to represent a string of characters, as is well known in the art of network communications. The unique message digest is compared to previous content requests received by each end node. If a node has previously seen the particular digest, the node will not act upon the request, thereby preventing request loops from occurring within the communications network.

A common problem with peer to peer networking techniques, however, is that such techniques lack location awareness. That is, a device has no knowledge of its geographic location in the network relative to a requesting device. In particular, there are instances when being either geographically close, geographically distant, or having a specific geographic location is important to a specific information request. For example, the user of a mobile peer to peer device may want to create a community of interest in a local geography to initiate a chat discussion on a topic of interest. Alternatively, taking another example, the user may need to find people within a geographic area to establish a mechanism to physically transport goods or services. A solution to provide location awareness in a peer to peer networking environment is therefore needed.

### SUMMARY OF THE INVENTION

The invention disclosed herein relates to a solution for generating a request for content or information in a communications network wherein the request contains geographic location information for a communication device generating the request. Notably, industry standard interfaces can be used to efficiently provide the geographic location information.

One aspect of the invention can include the step of specifying a query and determining the geographic location of a communication device. The query and geographic location are incorporated into a message digest, which can be a hash. At least one network node, which can be an additional communication device, is determined and the message digest is sent to the network node using a peer to peer protocol.

Geographic locations of the communication device and/or the network node can be determined by a positioning system, such as mobile positioning center or a global positioning satellite. The network node can compare the geographic location of the communication device to the geographic location of the network node and generate a location comparison. The network node then can perform at least one processing step responsive to the query and the location comparison. For example, if the network node is within a specified region or a specified radius from the communication device, the network node can perform a first process. If, however, the network node is not within the specified region or specified radius, the network node can perform a second process, such as forwarding the message digest to at least one additional network node.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a block diagram illustrating a system that includes communication devices operating as peer to peer nodes in a communications network in accordance with the inventive arrangements disclosed herein.

FIG. 2 is a block diagram illustrating an alternate embodiment of a system that includes communication devices operating as peer to peer nodes in a communications network in accordance with the inventive arrangements disclosed herein.

FIG. 3 is a flow chart illustrating a method of generating and processing content requests that incorporate geographic location information in accordance with the inventive arrangements disclosed herein.

### DETAILED DESCRIPTION OF THE INVENTION

The invention disclosed herein provides a solution for incorporating location information within peer to peer networks. A request for content or information is generated wherein the request contains geographic location information for a communication device generating the request. In particular, the geographic location information can be included in a message digest, which can further include a query and a communication device identifier. The query can include as a condition specific geographic parameters based upon the geographic location information. The content request can be propagated to other network nodes using a peer to peer network protocol. A node receiving the content request can analyze the message digest to determine if the node satisfies the geographic parameters and can fulfill the content request or provide the requested information. If a match for the request is found, the node can utilize the communication device's identifier to initiate direct communication with the communication device. If a match is not found, the node forwards the content request to additional nodes. This process continues until a time to live (TTL) counter reaches zero.

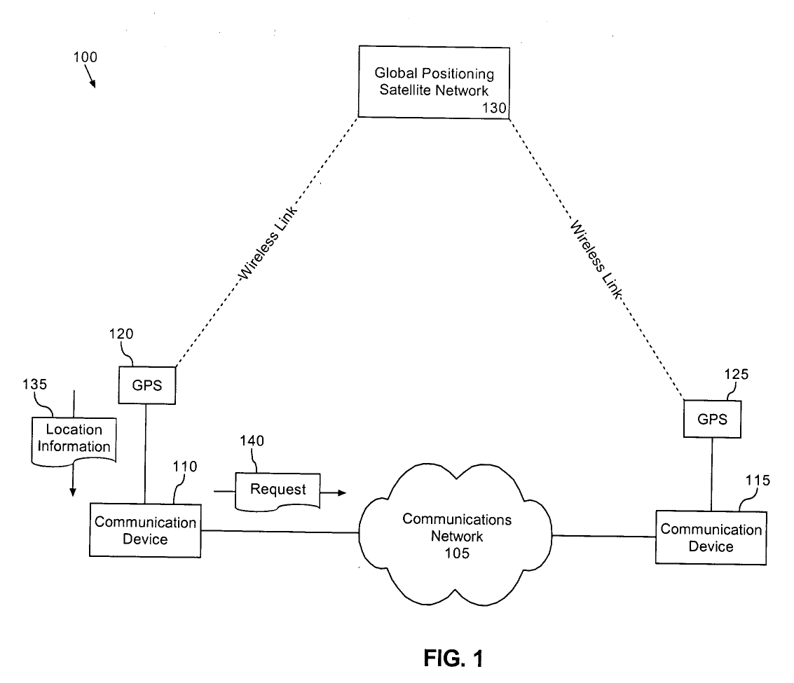

FIG. 1 is a block diagram illustrating a system 100 in accordance with the inventive arrangements disclosed herein. As shown in FIG. 1, the system 100 includes a communications network 105 which communicatively links communication devices (nodes) 110 and 115. Communications network 105 can be the Internet, a wide area network (WAN), a local area network (LAN), or the like. The communication devices 110 and 115 can include a computer, a personal digital assistant (PDA), a mobile telephone, a mobile radio, or any other portable or stationary communications device capable of communicating over a peer to peer network. The communications devices 110 and 1 15 can include the equipment necessary to communicate with other nodes in the communications network 105. Importantly, communication between communication devices 110 and 115 can be supported using a peer to peer networking protocol.

Communication devices 110 and 115 also can be communicatively linked to industry standard interfaces to efficiently and cost effectively provide the geographic location information for the devices. For example, global positioning satellite (GPS) receivers 120 and 125, respectively, can receive geographic location information 135 from a global positioning satellite network 130. In operation, communication device 110 can insert the geographic location information 135 in a message digest contained in request 140, as is further discussed below.

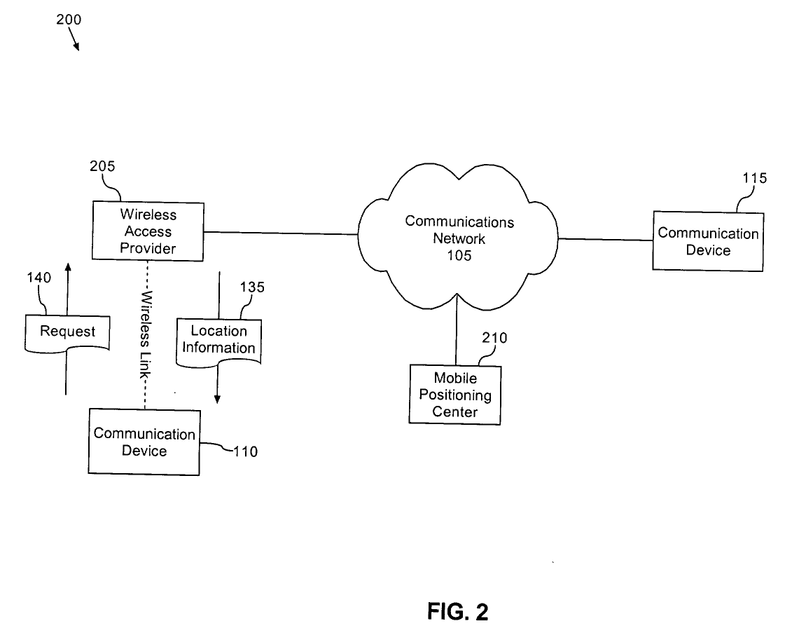

FIG. 2 is an alternative embodiment of the present invention. As shown in FIG. 2, a system 200 includes communications network 105 and communication devices 110 and 115. Communication devices 110 and 115 can be communicatively linked to the communications network 105. In particular, communication device 110 and/or communication device 115 can be linked to the communications network 105 via a wireless access provider 205. In this arrangement the wireless access provider 205 also can be communicatively linked with a mobile positioning center 210.

The mobile positioning center 210 can be used to determine the geographic location of the communication device 110 and/or 115. The techniques used by the mobile positioning center 210 for obtaining geographic location of a device are commonly known to those skilled in the art of mobile communications. Automatic location identification (ALI) is one such technique. The geographic location information 135 is forwarded from the mobile positioning center 210 to the communication device 110 via the wireless access provider 205. As previously noted, the communication device 110 can incorporate the geographic location information 135 into the message digest of a request 140.

Still, other techniques can be used to determine the geographic location of the communication device 110 and/or 115. In one arrangement the geographic location of a communication device 110 and/or 115 can be stored on a data storage and retrieved as needed. For example, the geographic location can be pre-programmed into the communication device itself. In another example, the geographic location can be stored in a data table residing on a computer communicatively linked to the communication device 110 and/or 115.

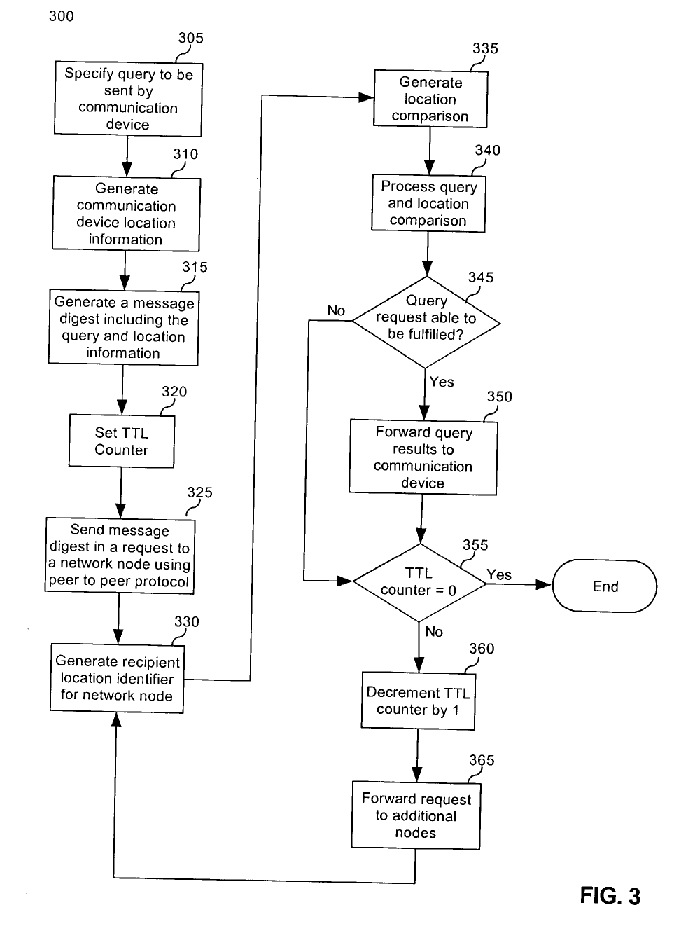

A flow chart 300 illustrating a method of generating and processing content and information requests that incorporate geographic location information is disclosed in FIG. 3. Beginning at step 305, a user can specify a query that is to be sent by communication device 110. The query can request content or information and also can include as a condition specific geographic parameters based upon geographic location information. For example, the query can request music files posted on the Internet by local artists who are located in the same city as the user, or the query can request information from moving companies located within a specific radius of the users location. In another example, a user can query to find a chat session including users within a specific region.

Referring to step 310, the location information 135 for the communication device 110 can be generated. As previously noted, a positioning system can be used to generate location information 135. In one arrangement the positioning system can be a GPS 125. In another embodiment a wireless access provider 205 or other centralized processing center can provide the geographic location information 135, for example using a mobile positioning center 210. Both solutions provide an efficient and cost effective way of collecting geographic location data.

Latitudinal and longitudinal coordinates are commonly used to specify geographic locations, but other methods can be used. For example, proximity detectors can detect the presence of a mobile communication device and specify the location information by an address, city, zip code, etc. In any case, the present invention is not so limited to the examples contained herein. Rather, any method or system for determining location information for a communication device 110 can be used.

Referring to step 315, a message digest including the query and the geographic location information 135 can be created. The message digest can be a hash formed by a client application. Notably, providing a message digest in the form of a hash provides an efficient means of indexing and retrieving searchable content over a network. In addition to the query and the geographic location information 135, the message digest can include the originator's identification, for example a network address for the communication device 110. Further, a time to live (TTL) counter can be included in the message digest to prevent an endless search in the case that a user's request cannot be filled, as shown in step 320.

Referring to step 325, the message digest can be forwarded in a request 140 to a network node. Importantly, the request 140 can be sent to the network node using a peer to peer network protocol. Accordingly, the network node can be a communication device 115 selected using any peer to peer node selection technique, as would be known by one skilled in the art of peer to peer network communications. For example, the communication device 110 can consult a stored table, centralized directory, or any other list that includes communication device 115.

Referring to step 330, upon communication device 115 receiving a request 140 from communication device 110, a recipient location identifier can be generated for communication device 115. For example, a GPS 125 or mobile positioning center 210 can be used to determine the communication device's 115 geographic location. Alternatively, if communication device 115 is in a permanent location, it can be pre-programmed with its geographic location information, as previously noted. The geographic location information 135 for communication device 110 can be extracted from the message digest received in the request 140. The geographic location information for the communication devices 110 and 115 then can be compared and a location comparison can be generated, as shown in step 335.

Referring to step 340, the query can be extracted from the message digest and processed by communication device 115 along with the location comparison. Communication device 115 can evaluate the location comparison and the query to determine whether the communication device 115 satisfies the request's geographic location criteria and is able to fulfill the request 140, as shown in decision block 345. For example, if the query is searching for sales information on a particular type of car that is located within a radius of 50 miles from communication device 110, communication device 115 can determine whether it is located within 50 miles of communication device 110 and whether it has sales information pertaining to the requested type of car. If communication device 115 can satisfy the location criteria and fulfill the request, the requested content or information can be forwarded from communication device 115 to communication device 110, as shown in step 350. Notably, the originator's identification provided in the message digest can be used to facilitate communication between the communication devices 110 and 115.

The communication device 115 then can evaluate the TTL counter as shown in decision block 355. If the TTL counter is not equal to zero, the TTL counter can be decremented by 1 and the request 140 can be forwarded to additional network nodes, as shown in steps 360 and 365. In the case where TTL counter has been decremented to zero, the search process can end.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method of peer to peer network communication, comprising the steps of:
in a communication device, specifying a query and a geographic location of said communication device;
generating a message digest including said query and said geographic location of said communication device;
determining at least one network node; and, sending said message digest to said network node using a peer to peer protocol.

2. The method of claim 1, further comprising the steps of:
comparing said geographic location of said communication device to a geographic location of said network node to generate a location comparison, said network node performing at least one processing step responsive to said query and said location comparison.

3. The method of claim 1, wherein said step of specifying a geographic location of said communication device further comprises the step of obtaining said geographic location from a positioning system.

4. The method of claim 3, wherein said positioning system comprises at least one of a mobile positioning center and a global positioning satellite.

5. The method of claim 1, wherein said message digest is a hash.

6. The method of claim 2, further comprising said network node communicating with a positioning system to specify said geographic location of said network node.

7. The method of claim 6, wherein said positioning system comprises at least one of a mobile positioning center and a global positioning satellite.

8. The method of claim 2, wherein said processing step comprises a first process if said geographic location of said network node is within a region specified by said message digest and a second process if said geographic location of said network node is not within a region specified by said message digest.

9. The method of claim 2, wherein said processing step comprises a first process if said geographic location of said network node is within a specified radius from said geographic location of said communication device and a second process if said geographic location of said network node is not within a specified radius from said geographic location of said communication device.

10. The method of claim 2, wherein said processing step comprises forwarding said message digest to at least one additional network node.

11. The method of claim 2, wherein said network node is an additional communication device.

12. A machine-readable storage, having stored thereon a computer program having a plurality of code sections executable by a machine for causing the machine to perform the steps of:
in a communication device, specifying a query and a geographic location of said communication device;
generating a message digest including said query and said geographic location of said communication device;
determining at least one network node; and, sending said message digest to said network node using a peer to peer protocol.

13. The machine readable storage of claim 12, further comprising the steps of:
comparing said geographic location of said communication device to a geographic location of said network node to generate a location comparison, said network node performing at least one processing step responsive to said query and said location comparison.

14. The machine readable storage of claim 12, wherein said step of specifying a geographic location of said communication device further comprises said communication device communicating with a positioning system.

15. The machine readable storage of claim 14, wherein said positioning system comprises at least one of a mobile positioning center and a global positioning satellite.

16. The machine readable storage of claim 12, wherein said message digest is a hash.

17. The machine readable storage of claim 13, further comprising said network node communicating with a positioning system to specify said geographic location of said network node.

18. The machine readable storage of claim 17, wherein said positioning system comprises at least one of a mobile positioning center and a global positioning satellite.

19. The machine readable storage of claim 13, wherein said processing step comprises a first process if said geographic location of said network node is within a region specified by said message digest and a second process if said geographic location of said network node is not within a region specified by said message digest.

20. The machine readable storage of claim 13, wherein said processing step comprises a first process if said geographic location of said network node is within a specified radius from said geographic location of said communication device and a second process if said geographic location of said network node is not within a specified radius from said geographic location of said communication device.

21. The machine readable storage of claim 13, wherein said processing step comprises forwarding said message digest to at least one additional network node.

22. The machine readable storage of claim 13, wherein said network node is an additional communication device.
